(19) United States
(12) Patent Application Publication
(10) Pub. No.: US 2006/0182579 A1
(43) Pub. Date: Aug. 17, 2006

(54) Convertible all-purpose utility trailer

(76) Inventor: Robert Maxwell, Deerfield Beach, FL (US)

Correspondence Address: Robert M. Downey, P.A., Ste. 300, 601 S. Federal Hwy, Boca Raton, FL, 33432, US

(21) Appl. No.: 11/356,289

(22) Filed: Feb. 16, 2006

Related U.S. Application Data
(60) Provisional application No. 60/653,455, filed on Feb. 16, 2005.

(51) Int. Cl. B60P 1/00; E02F 3/76; B62D 33/00

(52) U.S. Cl. 414/537; 280/124.1; 296/181.1; 280/80.1

(57) ABSTRACT

A trailer is provided with extendable and retractable left and right axle portions slidably supported within an axle sleeve, and hinged side panels to facilitate conversion of the trailer between a full size mode and a compact mode. In the full size mode, the left and right axle portions are extended and locked to position left and right tires at maximum separation, and the side deck panels are lowered to be generally co-planer with a center deck panel arrangement for towing behind a conventional vehicle. A front panel hinges between a raised position and a lowered position. In the compact mode, the left and right axle portions slide inwardly, within the sleeve, and lock into place to position the left and right tires closer together. The side panels and front panel swing upwardly to be generally perpendicular to the center deck panel assembly, forming a box. Left and right ramps are cooperatively structured to provide a cover and a rear wall to fully enclose the formed box. In the compact mode, the trailer can be towed behind a lightweight vehicle, such as an ATV, motorcycle or golf cart.

This application claims the benefit of the filing date of provisional patent application Ser. No. 60/653,455 filed on Feb. 16, 2005.

### BACKGROUND OF THE INVENTION

1. Field of the Invention

The present invention relates to trailers which are towed behind a vehicle and, more particularly, to a trailer which is operable between a full size mode for towing behind a conventional vehicle and a compact mode for towing behind a lightweight vehicle.

2. Discussion of the Related Art

All-terrain vehicles (ATV's) are becoming increasingly popular for both recreational and commercial use. Recent reports indicate that sales of ATV's have surpassed motorcycles in the past few years. While they are very common in rural areas, ATV's are also used extensively for commercial purposes, such as by beach and lifeguard patrols, police, government agencies, hotel and resort maintenance, private community maintenance and landscaping services. Outdoor enthusiasts often use ATV's when hunting, fishing and camping. ATV's are particularly useful for traveling extended distances across terrain which is not accessible to conventional road vehicles (i.e. cars, trucks and SUV's).

When used for hunting, fishing, camping and other general utility purposes, it is often desirous to transport supplies (e.g. food, firewood, etc.) and equipment (e.g. hunting, fishing and camping gear). In an effort to increase the otherwise limited carrying capacity of ATV's, many outdoor enthusiasts have retrofitted various racks, bins and compartments to the structure of their ATV, usually on the back end of the vehicle. These added structures often reduce the stability and safety of the ATV, particularly when loaded with equipment and supplies which has the effect of shifting the center of gravity to a less stable condition.

When traveling to a remote site, ATV's are commonly transported on a trailer which is towed behind a conventional road vehicle. When reaching the general vicinity of the site (e.g. a parking area), the ATV is unloaded from the trailer. Due to their size, and particularly the extensive wheel base, presently available trailers used for towing ATV's cannot, in turn, be towed behind the ATV when reaching the destination site (e.g. hunting, camping or fishing site). Thus, the present state of the art requires purchase and transport of two trailers in the event a person desires to tow a trailer behind their ATV when they reach a remote site. More specifically, a full size trailer is required to transport the ATV to the remote site and a second compact trailer is needed for towing behind the ATV at the destination site.

Accordingly, there remains a need in the art for a trailer that can be towed behind a conventional road vehicle and which converts to a compact size for towing behind a lightweight vehicle such as an ATV, motorcycle or golf cart.

### OBJECTS AND ADVANTAGES OF THE INVENTION

With the foregoing in mind, it is a primary object of the present invention to provide a trailer which converts from a full size mode for towing behind a conventional vehicle and a compact mode for towing behind a smaller, lightweight vehicle.

It is a further object of the present invention to provide a convertible trailer, as set forth above, which is structured for supporting and carrying an ATV thereon when in a full size mode and, further, wherein the trailer converts to the compact mode for towing behind the ATV or other lightweight vehicle.

It is still a further object of the present invention to provide a convertible trailer, as set forth above, which converts between the full size mode and the compact mode with ease, by one person, and without the need for special tools or equipment.

It is still a further object of the present invention to provide a convertible trailer, as set forth above, which is relatively lightweight and which can be partially disassembled for transport in the rear bed of a pick up truck or full size sport utility vehicle.

It is yet a further object of the present invention to provide a convertible trailer, as set forth above, which provides a closed box structure when in the compact mode, for protectively carrying equipment and supplies.

These and other objects and advantages of the present invention are more readily apparent with reference to the following detailed description and accompanying drawings.

### SUMMARY OF THE INVENTION

The present invention is directed to a trailer which converts between a full size mode for towing behind a conventional road vehicle and a compact mode for towing behind a lightweight vehicle, such as an ATV or motorcycle. The trailer is provided with extendable and retractable left and right axle portions slidably supported within an axle sleeve, and hinged side panels to facilitate conversion of the trailer between a full size mode and a compact mode. In the full size mode, the left and right axle portions are extended and locked to position left and right tires at maximum separation, and the side deck panels are lowered to be generally co-planer with a center deck panel assembly. In the full size mode, the trailer can be used for hauling anything from furniture to motorcycles or an all terrain vehicle (ATV) behind a conventional vehicle. In the compact mode, the left and right axle portions slide inwardly, within the sleeve, and lock into place to position the left and right tires closer together. The side panels and a front panel swing upwardly to be generally perpendicular to the center deck panel assembly, forming a box. Left and right ramps are cooperatively structured to provide a cover and a rear wall to fully enclose the formed box. In the compact mode, the trailer can be towed behind a lightweight vehicle, such as an ATV, motorcycle or golf cart.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view showing the component parts of the Convertible Trailer in accordance with a preferred embodiment thereof;

FIG. 1a is an isolated cross-sectional view taken along line 1A-1A in FIG. 1;

FIG. 2 is a rear elevational view showing the Convertible Trailer in a full size mode;

FIG. 3 is a rear elevational view showing the Convertible Trailer in a compact mode; and

FIG. 4 is a side elevational view showing the Convertible Trailer with the ramp lowered and extending from a rear of the trailer;

FIG. 5 is a side elevational view of the Convertible Trailer shown with the ramp raised and closed over the top of the trailer with the side panels folded up in the collapsed mode;

FIG. 6 is an isolated cross-sectional view taken along line 6-6 in FIG. 1;

FIG. 6A is an isolated cross-sectional view taken from the same area as FIG. 6 and showing the rear center panel being raised; and

FIG. 7 is an isolated cross-sectional view taken along line 7-7 in FIG. 1.

Like reference numerals refer to like parts throughout the several views of the drawings.

### DETAILED DESCRIPTION OF THE PREFERRED EMBODIMENTS

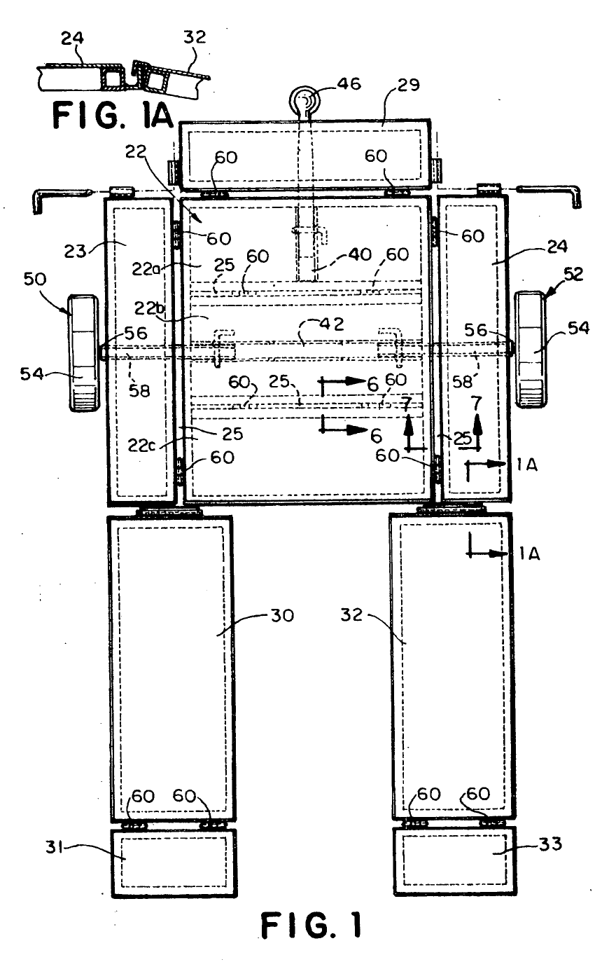

Referring initially to FIG. 1, the convertible trailer is shown in a top plan view and is generally indicated as 10.

The convertible trailer 10 comprises primarily a deck structure 20, left and right ramps 30,32, a coupler sleeve 40 and an axle sleeve 42 fixed to an underside of the deck structure, a coupler 46 for sliding receipt within the coupler sleeve 40, an left wheel assembly 50 and a right wheel assembly 52. The left and right wheel assemblies each include tires 54 and an axle structure 56 including axle extensions 58. The axle extensions are structured and disposed for sliding, telescoping receipt through the opposite ends of the axle sleeve.

The deck structure 20 includes a center deck assembly 22 defining a main deck portion of the trailer. In a preferred embodiment, the center deck assembly 22 includes an arrangement of deck panels that are hinged together including a forward center deck panel 22a, a middle center deck panel 22b and a rear center deck panel 22c. The coupler sleeve 40 and axle sleeve 42 are fixed to an underside of the middle center deck panel 22b. The deck structure of the trailer further includes left and right side panels 23, 24 hinged to the center deck 22 and a front panel 29 hinged to the forward center deck panel 22a of the center deck 22.

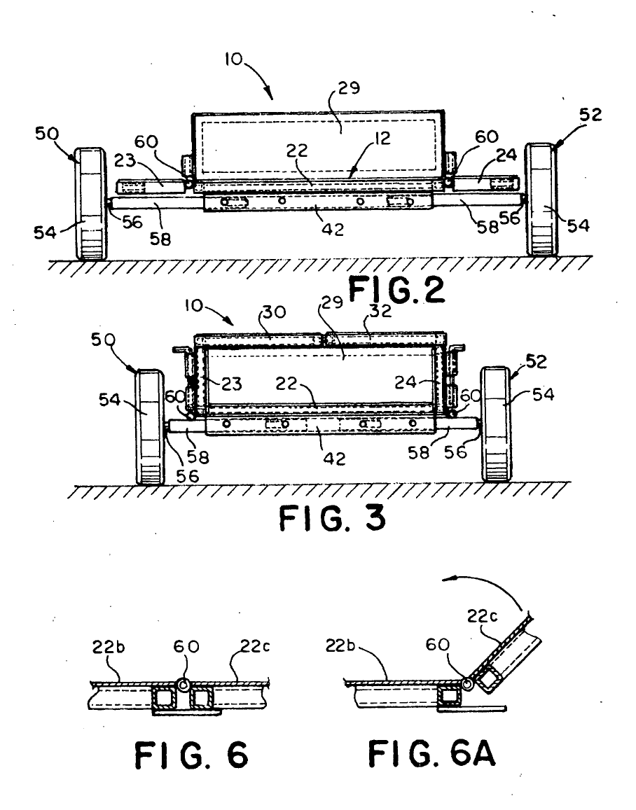

The axle extensions 58 of the left and right wheel assemblies 50, 52 and the panels of the deck structure 20 are operatively movable to allow conversion of the trailer between a full size mode, as shown in FIG. 2 and a compact mode as shown in FIG. 3. In the full size mode, the left and right wheel assemblies are moved to a fully extended outboard position by sliding the axle extensions 58 outward relative to the axle sleeve 42. At the fully extended outboard position, the axle portions of the left and right wheel assemblies are locked into place within the axle sleeve with pins or bolts which are received through aligning holes formed through the axle sleeve and axle portions within the sleeve. A spring loaded locking pin, clip or like hardware mechanism is used to secure the bolts or pins in locked receipt through the axle sleeve and axle portions to maintain the left and right wheel assemblies 50,52 at the fully extended outboard position, as seen in FIG. 2. In this full size mode, the left and right side panels 23, 24 are lowered to be coplanar with the center deck 22. The front panel 29 may be lowered as well to provide maximum deck area to support cargo, equipment, motorcycles or a lightweight vehicle such as an ATV.

The left and right ramps 30,32 are removably positionable in engaging receipt on the rear edge of the rear center deck panel 22c and the lowered side panels 23,24 to permit loading and unloading of an ATV or other vehicles or equipment on and off of the enlarged deck structure of the trailer. FIG. 1A shows a detail of the removable attachment of the ramps to the rear of the deck structure. The hinges 60 for the left and right panels 23,24 and front panel are preferably of a type which permits releasable locked positioning of the panels 23,24 and 29 at the lowered position, as seen in FIG. 2, and a raised position, as seen in FIG. 3, wherein the panels 23,24 and 29 are generally perpendicular to the center deck assembly 22.

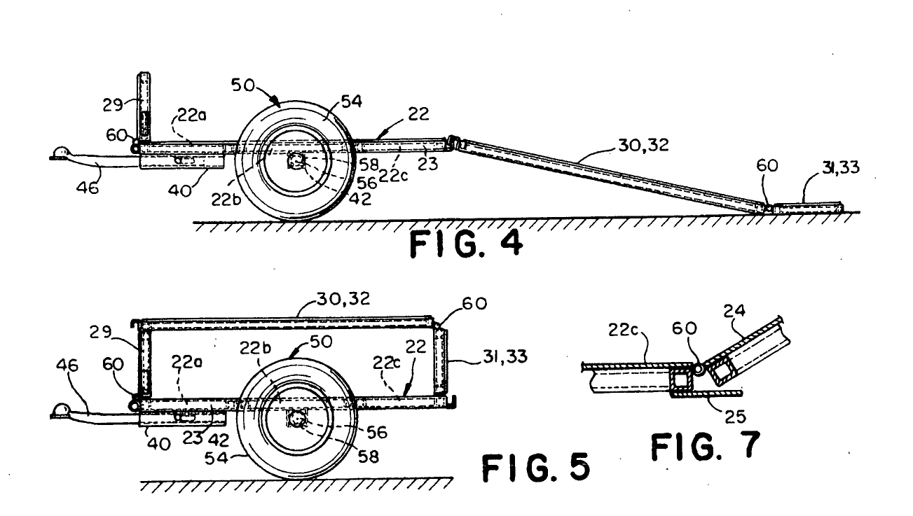

When converting from the full size mode to the compact mode, the left and right ramps 30, 32 are first removed. Next, the left and right side panels 23, 24 are raised to be generally vertical and perpendicular to the center deck assembly 22. The hinges 60 may lock the left and right side panels 23, 24 into this raised position, as seen in FIG. 3. The front panel 29 can then be raised to be generally vertical and perpendicular to the center deck and left and right side panels. Again, the hinges 60 on the front panel 29 may be structured to releasably lock the front panel in the raised position. Alternatively, pins or other locking hardware may be used to secure the side panels 23, 24 and the front panel 29 in the raised position. When the panels are all in the raised position, as seen in FIG. 3, an open top box is formed and the overall width of the trailer deck structure is reduced. This allows the left and right wheel assemblies 50, 52 to be moved inboard by releasing the pins from the axle sleeve 42 and axle extensions 58 and sliding the axle extensions of the respective left and right wheel assemblies inwardly, through the axle sleeve 42 until the holes in the axle extensions 58 align with a second arrangement of holes in the axle sleeve. The axle extensions 58 can then be locked within the axle sleeve 42 using bolts or spring loaded lock pins. In this position, as seen in FIG. 3, the tires 54 of the left and right wheel assemblies are moved inwardly to a minimal distance of separation, allowing the trailer to be conveniently towed behind a lightweight vehicle, such as an ATV or motorcycle. The left and right ramps 30, 32 are structured to be fitted onto the open top of the box structure formed by the raised panels. End panels 31, 33 on the ramps fold down to provide a rear wall (see FIG. 5), thereby completing an enclosed box structure. This allows equipment and supplies to be protectively carried within the enclosed box structure on the trailer when towed behind the lightweight vehicle.

To facilitate transport of the deck structure when the left and right wheel assemblies are removed, rollers may be provided on the underside of the center deck, towards the forward end. With the coupler 46 removed from the coupler sleeve 40, the rear edge of the deck structure may be lifted, allowing a single person to pull the deck structure along a ground surface as the forward rollers (not shown) engage the underlying ground surface.

The trailer 10 can be transported in the back of a pick up truck or a full size SUV when in the compact mode. To further reduce the overall size of the trailer, when in the compact mode, the left and right wheel assemblies and the coupler can be removed.

While the instant invention has been shown and described in accordance with a preferred and practical embodiment thereof, it is recognized that departures from the instant disclosure are contemplated within the spirit and scope of the present invention.

What is claimed is:

1. A trailer to be towed behind a towing vehicle and comprising:
a deck structure including a center deck assembly having a top side, a bottom side, a front edge, a left side edge, a right side edge, and a rear edge;
said deck structure further including a left side panel assembly movably attached to said left side edge of said center deck assembly, a right side panel assembly movably attached to said right side edge of said center deck assembly, and said left and right side panel assemblies being operatively movable between a lowered position in coplanar relation to said center deck assembly and a raised position in perpendicular relation to said center deck assembly;
a left wheel assembly and a right wheel assembly, said left and right wheel assemblies each including a wheel rim, a tire on the wheel rim, and an axle extension;
an axle sleeve transversely mounted below said center deck assembly and being structured and disposed for sliding receipt of said axle extensions of said left and right wheel assemblies so that said wheel rim and said tire of said left wheel assembly is positioned outboard of said left side edge of said center deck assembly and said wheel rim and said tire of said right wheel assembly is positioned outboard of said right side edge of said center deck assembly, and said axle extension of each of said left and right wheel assemblies being adjustably positionable within said axle sleeve at at least two adjusted positions including a first outboard position, wherein said wheel rim and said tire are positioned closer to said center deck assembly and a second outboard position wherein said wheel rim and said tire are positioned further away from said center deck assembly in order to allow movement of said left and right side panel assemblies to said lowered position in coplanar relation to said center deck assembly;
at least one ramp removably attachable to said rear edge of said center deck assembly at a downwardly angled position so that a distal end portion of said ramp rests on a ground surface behind said center deck assembly, and said at least one ramp being structured and disposed to be placed above said center deck assembly and between said left and right side panels when said left and right side panels are in the raised position, so that said at least one ramp defines a cover; and
a coupler extending forwardly of said front edge of said center deck assembly for hitching said trailer to the towing vehicle.

2. The trailer as recited in claim 1 further comprising:
said deck structure further including a front panel assembly movably attached to said front edge of said center deck assembly and being operatively movable between a lowered position in coplanar relation to said center deck assembly and a raised position in perpendicular relation to said center deck assembly.

3. The trailer as recited in claim 2 wherein said at least one ramp is structured and disposed to provide a rear wall between said left and right side panel assemblies when said left and right side panel assemblies are in said raised position and said at least one ramp is placed above said center deck assembly to provide said cover.

4. The trailer as recited in claim 3 wherein said left and right side panel assemblies, said front panel assembly, said center deck assembly and said at least one ramp are structured and disposed to form a closed box structure with an enclosed interior storage chamber.

5. The trailer as recited in claim 4 further comprising:
two of said ramps, including a left ramp and a right ramp, and said left and right ramps being supported by said left and right side panel assemblies and said front panel assembly when placed above said center deck assembly to define said cover.

6. The trailer as recited in claim 4 wherein said at least one ramp comprises:
a hinged panel at said distal end portion, and said hinged panel defining said rear wall when said at least one ramp is placed above said center deck assembly to define said cover.

7. The trailer as recited in claim 5 wherein said left and right ramps each comprise:
a hinged panel at said distal end portion and defining at least a portion of said rear wall when said left and right ramps are placed above said center deck assembly and supported by said left and right side panel assemblies and said front wall assembly to define said cover.

8. The trailer as recited in claim 1 further comprising:
a coupler sleeve mounted below said center deck assembly for sliding, removable and interlocked receipt of said coupler therein.
